(19) United States
(12) Patent Application Publication
(10) Pub. No.: US 2026/0265493 A1
(43) Pub. Date: Sep. 10, 2026

(54) MOLDED POLYIMIDE ARTICLE

(71) Applicant: DuPont Specialty Products USA, LLC, WILMINGTON, DE (US)

(72) Inventors: HAU-NAN LEE, WILMINGTON, DE (US); PETER FOX, NEWARK, DE (US); LEE SILVERMAN, PORTO (PT); VIVEK KAPUR, WILMINGTON, DE (US)

(21) Appl. No.: 19/162,161

(22) PCT Filed: Mar. 19, 2024
(86) PCT No.: PCT/US2024/020543

§ 371 Date: Sep. 4, 2025

Related U.S. Application Data
(60) Provisional application No. 63/494,836, filed on Apr. 7, 2023.

(51) Int. Cl. C08K 7/00; C08G 73/10; C08K 3/34

(52) U.S. Cl. CPC C08K 7/00; C08G 73/1042; C08G 73/1067; C08K 3/346; C08G 2140/00; C08K 2201/005

(57) ABSTRACT

Provided herein is a molded polyimide article having excellent insulating properties and mechanical properties, which is useful for electronic components. The molded polyimide article has lower than 5 of dielectric constant and at least 7.5 GPa of flexural modulus, and formed from a composition comprising (A) at least 30 weight % of at least one sheet silicate, based on the weight of the polyimide composition, and (B) at least one polyimide.

### TECHNICAL FIELD

This invention relates to a molded insulating polyimide article useful for electronic components. In particular, the molded insulating polyimide article has low dielectric constant and excellent flexural modulus, which is formed from a composition comprising high amount of sheet silicate and at least one polyimide.

### BACKGROUND

Polyimide compositions are useful in a wide variety of applications due to the unique performance characteristics of polyimide compositions under stress and high temperatures. Polyimide compositions can be processed and used as a form of bushings, seals, piston rings, gears, cams and thrust plugs.

However, for the use that is needed higher stiffness property, polyimide composition is difficult to use because of its mechanical properties. Additives are used to improve the characteristics of polyimide compositions. For example, U.S. Pat. No. 5,789,523 discloses polyimide compositions comprising up to 30 wt % of sheet silicate, to improve wear resistance and friction. WO2017/197077 discloses polyimide compositions comprising titanium oxide. However, the polyimide compositions disclosed in U.S. Pat. No. 5,789,523 focuses on its wear resistance and friction properties, and not enough for modulus of an article. The polyimide compositions disclosed in WO2017/197077 shows high dielectric constant because of the high dielectric property of titanium dioxide, so the polyimide compositions cannot be used for insulating materials. Therefore, normally ceramics are used for the purpose.

Although ceramics have excellent insulating properties, thermal conductivity and stability, the weight of a ceramic article is heavy and it is difficult to form a complexing article. Therefore, a material which shows low dielectric constant and high flexural modulus with easy processability is required.

### BRIEF SUMMARY

New molded polyimide insulating article having low dielectric constant and high flexural modulus is developed.

The invention is directed to a molded polyimide insulating article formed from a composition comprising
(A) at least one polyimide, and
(B) 30 to 70 weight % of at least one sheet silicate, based on the weight of the polyimide composition,
wherein the dielectric constant of the molded insulating polyimide article is lower than 5 and the flexural modulus of the molded insulating polyimide article is at least 7.5 GPa.

### DETAILED DESCRIPTION

Polyimides used in the composition may contain the characteristic —CO—R—CO— group as a linear or heterocyclic unit along the main chain of the polymer backbone. The polyimide can be obtained, for example, from the reaction of monomers such as an organic tetracarboxylic acid, or the corresponding anhydride or ester derivative thereof, with an aliphatic or aromatic diamine.

A polyimide precursor as used to prepare a polyimide is an organic polymer that becomes the corresponding polyimide when the polyimide precursor is heated or chemically treated. In certain embodiments of the thus-obtained polyimide, about 60 to 100 mole percent, preferably about 70 mole percent or more, more preferably about 80 mole percent or more, of the repeating units of the polymer chain thereof has a polyimide structure as represented, for example, by the following formula:

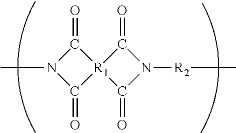

wherein R1 is a tetravalent aromatic radical having 1 to 5 benzenoid-unsaturated rings of 6 carbon atoms, the four carbonyl groups being directly bonded to different carbon atoms in a benzene ring of the R1 radical and each pair of carbonyl groups being bonded to adjacent carbon atoms in the benzene ring of the R1 radical; and R2 is a divalent aromatic radical having 1 to 5 benzenoid-unsaturated rings of carbon atoms, the two amino groups being directly bonded to different carbon atoms in the benzene ring of the R2 radical.

Preferred polyimide precursors are aromatic, and provide, when imidized, polyimides in which a benzene ring of an aromatic compound is directly bonded to the imide group. An especially preferred polyimide precursor includes a polyamic acid having a repeating unit represented, for example, by the following general formula, wherein the polyamic acid can be either a homopolymer or copolymer of two or more of the repeating units:

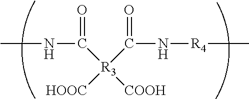

wherein R3 is a tetravalent aromatic radical having 1 to 5 benzenoid-unsaturated rings of 6 carbon atoms, the four carbonyl groups being directly bonded to different carbon atoms in a benzene ring of the R3 radical and each pair of carbonyl groups being bonded to adjacent carbon atoms in the benzene ring of the R3 radical; and R4 is a divalent aromatic radical having 1 to 5 benzenoid-unsaturated rings of carbon atoms, the two amino groups being directly bonded to different carbon atoms in the benzene ring of the R4 radical.

Typical examples of a polyamic acid having a repeating unit represented by the general formula above are those obtained from pyromellitic dianhydride (PMDA) and diaminodiphenyl ether (ODA); and 3,3′,4,4′-biphenyltetracarboxylic dianhydride (BPDA) and ODA. When subjected to ring closure, the former becomes poly(4,4′-oxydiphenylenepyromellitimide) and the latter becomes poly(4,4′-oxydiphenylene-3,3′,4,4′-biphenyltetracarboxy imide).

A typical example of a polyimide prepared by a solution imidization process is a rigid, aromatic polyimide composition having the recurring unit:

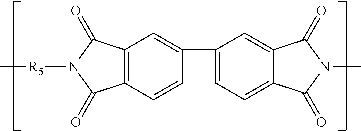

wherein R₅ is p-phenylene diamine (PPD).

Another example of a polyimide prepared by a solution imidization process is a rigid, aromatic polyimide composition wherein R5 is greater than 60 to about 85 mole percent PPD units and about 15 to less than 40 mole percent m phenylene diamine (MPD) units.

The tetracarboxylic acids preferably employed in the practice of the invention, or those from which derivatives useful in the practice of this invention can be prepared, are those having the general formula:

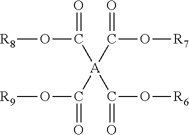

wherein A is a tetravalent organic group and R6 to R9, inclusive, comprise hydrogen or a lower alkyl, and preferably methyl, ethyl, or propyl. The tetravalent organic group A preferably has one of the following structures:

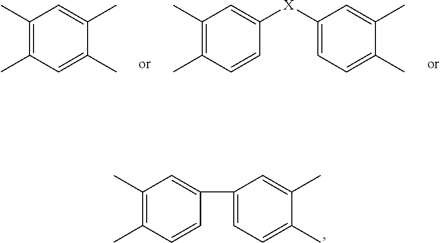

wherein X comprises at least one of —(CO)—, —O—, —S—, —SO2-, —CH2-, —C(CH3)2-, and —C(CF3)2-.

As the aromatic tetracarboxylic acid component, there can be mentioned aromatic tetracarboxylic acids, acid anhydrides thereof, salts thereof and esters thereof. Examples of the aromatic tetracarboxylic acids include 3,3′,4,4′-biphenyltetracarboxylic acid, 2,3,3′,4′-biphenyltetracarboxylic acid, pyromellitic acid, 3,3′,4,4′-benzophenonetetracarboxylic acid, 2,2-bis(3,4-dicarboxyphenyl)propane, bis(3,4-dicarboxyphenyl)methane, bis(3,4-dicarboxyphenyl)ether, bis(3,4-dicarboxyphenyl)thioether, bis(3,4-dicarboxyphenyl)phosphine, 2,2-bis(3′,4′-dicarboxyphenyl)hexafluoropropane, 2,2-bis[4-(3,4-dicarboxyphenoxy)phenyl]propane dianhydride, and bis(3,4-dicarboxyphenyl)sulfone.

These aromatic tetracarboxylic acids can be employed singly or in combination. Preferred is an aromatic tetracarboxylic dianhydride, and particularly preferred are BPDA, PMDA, 3, 3′, 4,4′-benzophenonetetracarboxylic dianhydride, and mixtures thereof.

As an organic aromatic diamine, use is preferably made of one or more aromatic and/or heterocyclic diamines, which are themselves known to the art. Such aromatic diamines can be represented by the structure: H2N—R10-H2, wherein R10 is an aromatic group containing up to 16 carbon atoms and, optionally, containing up to one heteroatom in the ring, the heteroatom comprising —N—, —O—, or —S—. Also included herein are those R10 groups wherein R10 is a diphenylene group or a diphenylmethane group.

Representative of such diamines are 2,6-diaminopyridine, 3,5-diaminopyridine, m-phenylenediamine, p-phenylene diamine, ρ,ρ′-methylene dianiline, 2,6-diaminotoluene, and 2,4-diaminotoluene.

Other examples of the aromatic diamine components, which are merely illustrative, include benzene diamines such as 1,4-diaminobenzene, 1,3-diaminobenzene, and 1,2-diaminobenzene; diphenyl(thio)ether diamines such as 4,4′-diaminodiphenylether, 3,4′-diaminodiphenylether, 3,3′-diaminodiphenylether, and 4,4′-diaminodiphenylthioether; benzophenone diamines such as 3,3′-diaminobenzophenone and 4,4′-diaminobenzophenone; diphenylphosphine diamines such as 3,3′-diaminodiphenylphosphine and 4,4′-diaminodiphenylphosphine; diphenylalkylene diamines such as 3,3′-diaminodiphenylmethane, 4,4′-diaminodiphenylmethane, 3,3′-diaminodiphenylpropane, and 4,4′-diaminodiphenylpropane; diphenylsulfide diamines such as 3,3′-diaminodiphenylsulfide and 4,4′-diaminodiphenylsulfide; diphenylsulfone diamines such as 3,3′-diaminodiphenylsulfone and 4,4′-diaminodiphenylsulfone; and benzidines such as benzidine and 3,3′-dimethylbenzidine.

Other useful diamines have at least one non-heteroatom containing aromatic rings or at least two aromatic rings bridged by a functional group.

These aromatic diamines can be employed singly or in combination. Preferably employed as the aromatic diamine component are 1,4-diaminobenzene, 1,3-diaminobenzene, 4,4′-diaminodiphenylether, and mixtures thereof.

A polyamic acid can be obtained by polymerizing an aromatic diamine component and an aromatic tetracarboxylic acid component preferably in substantially equimolar amounts in an organic polar solvent. The amount of all monomers in the solvent can be in the range of about 5 to about 40 weight percent, more preferably in the range of about 6 to about 35 weight percent, and most preferably in the range of about 8 to about 30 weight percent. The temperature for the reaction generally is not higher than about 100° C., preferably in the range of about 10° C. to 80° C. The time for the polymerization reaction generally is in the range of about 0.2 to 60 hours.

The process by which a polyimide is prepared can also vary according to the identity of the monomers from which the polymer is made up. For example, when an aliphatic diamine and a tetracarboxylic acid are polymerized, the monomers form a complex salt at ambient temperature. Heating of such a reaction mixture at a moderate temperature of about 100 to about 150° C. yields low molecular weight oligomers (for example, a polyamic acid), and these oligomers can, in turn, be transformed into higher molecular weight polymer by further heating at an elevated temperature of about 240 to about 350° C. When a dianhydride is used as a monomer instead of a tetracarboxylic acid, a solvent such as dimethylacetamide or N-methylpyrrolidinone is typically added to the system. An aliphatic diamine and dianhydride also form oligomers at ambient temperature, and subsequent heating at about 150 to about 200° C. drives off the solvent and yields the corresponding polyimide.

As an alternative to the use of an aliphatic diamine and/or an aliphatic diacid or dianhydride, as described above, an aromatic diamine is typically polymerized with a dianhydride in preference to a tetracarboxylic acid, and in such a reaction a catalyst is frequently used in addition to a solvent. A nitrogen-containing base, phenol, or amphoteric material can be used as such a catalyst. Longer periods of heating can be needed to polymerize an aromatic diamine.

The ring closure can also be effected by conventionally used methods such as a heat treatment or a process in which a cyclization agent such as pyridine and acetic anhydride, picoline and acetic anhydride, 2,6-lutidine and acetic anhydride, or the like is used.

Preferred the polyimides used herein are infusible polyimides. In some preferred polyimides essentially all of the connecting groups are imide groups. Preferred polyimides include those made from: a tetracarboxylic anhydride (for example PMDA and/or BPDA) and about 60 to about 85 mole percent PPD and about 15 to about 40 mole percent MPD (see U.S. Pat. No. 5,886,129, which is hereby included by reference); BPDA and MPD, maleic anhydride and bis(4-aminophenyl)methane; 3,3′,4,4′-benzophenone tetracarboxylic dianhydride, toluenediamine and MPD, 3,3′,4,4′-benzophenone tetracarboxylic dianhydride, bis(4-aminophenyl)methane and nadic anhydride; trimellitic anhydride and MPD; trimellitic anhydride and bis(4-aminophenyl)ether; BPDA and bis(4-aminophenyl)ether; BPDA and MPD; BPDA and PPD; 3,3′,4,4′-benzophenone tetracarboxylic dianhydride and 4,4′-diaminobenzophenone. An especially preferred polyimide is a polyimide made from a tetracarboxylic anhydride (for example PMDA and/or BPDA) and about 60 to about 85 mole percent PPD and about 15 to about 40 mole percent MPD; and/or PMDA and/or BPDA and ODA.

The polyimide composition may comprise from about 30 wt % to about 70 wt % polyimide powder. In embodiments, the polyimide composition comprises 40 wt %, 50 wt %, 60 wt %, and 70 wt %, polyimide powder. The polyimide powder may be a polyimide polymer that is a rigid polyaromatic polyimide derived from BPDA and PPD.

In an embodiment, the polyimide composition may comprise from about 30 wt % to about 70 wt % polyimide powder that is a rigid polyaromatic polyimide derived from BPDA and PPD.

In an embodiment, the polyimide composition may comprise from about 30 wt % to about 70 wt % polyimide powder that is a rigid polyaromatic polyimide derived from BPDA, MPD, and PPD.

In an embodiment, the polyimide composition may comprise from about 30 wt % to about 70 wt % polyimide polymer that is a rigid polyaromatic polyimide derived from PMDA and ODA.

Sheet silicate described herein has strong two-dimensional bonding within the silicate layers, but weak inter-layer bonding between two or more of silicate layers.

Sheet silicate contains Si4+ and also may contain any other tetrahedrally coordinated cation such as Ti4+, Al3+, Fe3+, B3+, P5+, As5+, V5+, Mg2+, Fe2+, Mn2+, Zn2+ and possibly S6+, Cr6+ and Li+. Sheet silicate includes clay, mica, hydrotalcite, and scaly silica microparticles.

Examples of clay include; smectite, halloysite, canemite, kenyite, zirconium phosphate and titanium phosphate.

Examples of smectite include; montmorillonite, beidellite, nontronite, saponite, hectorite, sauconite and stevensite.

The sheet silicate described herein may be incorporated into the polyimide compositions described herein by adding at any stage during the preparation of polyamic acid. The sheet silicate may be added to the organic solvent prior event to the introduction of the diamine and the dianhydride. It also may be added to the solution in the organic solvent of one or both of the reactants before, during, or after the formation of the polyamic acid. It also may be added to the polyimide powder precipitated and dried to remove the solvent. In an embodiment, the sheet silicate is added to a solution of polyamic acid.

The sheet silicate may represent from 30% wt % to 70 wt %, of the total weight of polyimide composition (i.e. the sum of polyimide, sheet silicate and other additives if there is), preferably from 35 to 70 wt % of the total weight of polyimide composition. More preferably, the amount of sheet silicate is from 35 to 65 wt %, further preferably from 40 to 55 wt %, based on the weight of the polyimide composition.

The use of less than 30 wt % does not provide an enough modulus of an article formed from the composition.

The use of amounts greater than 90 wt % and with some polyimides greater than about 70 wt % (about 200 wt % based on the weight of the polyimide) tends to weaken the product and does limit its usefulness.

The polyimide composition can comprise other additives such as boron nitride, silica, glass fiber, silica carbide fiber, glass sphere, hollow glass sphere, and Kevlar® powder.

An article can be prepared from the polyimide composition. Any known method can be used. Exemplary, polyimide composition powder can be converted into an article by direct forming (DF) at a pressure of 100,000 psi (689 MPa) at room temperature, then sintered for 8 hours to 150 hours at a temperature up to 420° C. under nitrogen at atmospheric pressure. Alternatively, polyimide composition powder can be put into a mold then heated at a pressure of from 1,000 psi to 100.00 psi, at 250° C. to 420° C. The article can be a test socket housing, a burn-in socket housing, a wafer level package probe head material, and a chemical mechanical polishing retainer ring.

### EXAMPLES

In the examples, flex modulus was measured using ASTM D790.

Dielectric constant was measured using ASTM D150.

### Raw Materials

Mica: Optifine grade mica, obtained from CB minerals LLC.

Talc: Talcron MP 10-52, obtained from Brenntag North America, Inc.

Kaolinite: Polyfil® DL, obtained from KaMin LLC

### Blending Methods

### A: Dry Blending

Example 1: Particles of a polyimide made from 3,3′,4,4′-biphenyltetracarboxylic acid dianhydride (BPDA), m-phenylenediamine (MPD), and p-phenylenediamine (PPD) (1:1 molar ratio BPDA to combined PPD and MPD; and 70/30 wt % ratio of PPD/MPD) were prepared according to the method described in U.S. Pat. No. 5,886,129 (specifically Example 1). Then, 46 wt % of mica was added with the polyimide particles. Mixing of polyimide/mica was achieved using a Waring blender at 22,000 rpm for 5 min. Bars made were measured to have a flex modulus of 9,700 MPa.

Example 2: Particles of a polyimide was prepared according to Example 1 above. Then, 45 wt % of talc was added with the polyimide particles. Mixing of polyimide/talc was achieved using a Waring blender at 22,000 rpm for 5 min. Bars made were measured to have a flex modulus of 7,800 MPa.

Example 3: Particles of a polyimide was prepared according to Example 1 above. Then, 44 wt % of kaolinite was added with the polyimide particles. Mixing of polyimide/kaolinite was achieved using a Waring blender at 22,000 rpm for 5 min. Bars made were measured to have a flex modulus of 10,400 MPa

### B: Reactor Blending

Example 4: Particles of a polyimide composition containing 55% of a polyimide made from BPDA, PPD, & MPD (1:1 molar ratio BPDA to combined PPD and MPD; and 70/30 wt % ratio of PPD/MPD) and 45 wt % talc (Talcron MP 10-52 Montana Talc) were prepared according to the method described in U.S. Pat. No. 5,886,129 (specifically Example 7). Bars made were measured to have a flex modulus of 11,100 MPa

Example 5: Particles of a polyimide composition containing 50% of a polyimide made from BPDA, PPD, & MPD (1:1 molar ratio BPDA to combined PPD and MPD; and 70/30 wt % ratio of PPD/MPD) and 50 wt % talc (Talcron MP 10-52 Montana Talc) were prepared according to Example 4 above. Bars made were measured to have a flex modulus of 10,400 MPa

Example 6: Particles of a polyimide composition containing 65% of a polyimide made from BPDA, PPD, & MPD (1:1 molar ratio BPDA to combined PPD and MPD; and 70/30 wt % ratio of PPD/MPD) and 35 wt % kaolinite (Kaolinite) were prepared according to the method described in U.S. Pat. No. 5,886,129 (specifically Example 6). Bars made were measured to have a flex modulus of 11.2 MPa).

Example 7: Particles of a polyimide composition containing 55% of a polyimide made from BPDA, PPD, & MPD (1:1 molar ratio BPDA to combined PPD and MPD; and 70/30 wt % ratio of PPD/MPD) and 45 wt % talc (Talcron MP 10-52 Montana Talc) were prepared according to Example 6 above. Bars made were measured to have a flex modulus of 9925 MPa).

Example 8: Particles of a polyimide composition containing 54% of a polyimide made from BPDA, PPD, & MPD (1:1 molar ratio BPDA to combined PPD and MPD; and 70/30 wt % ratio of PPD/MPD) and 46 wt % mica (Optifine, CB minerals) were prepared according to Example 6 above. Bars made were measured to have a flex modulus of 10777 MPa.

Example 9 (Comparative Example): Particles of a polyimide made from BPDA, PPD & MPD (1:1 molar ratio BPDA to combined PPD and MPD; and 70/30 wt % ratio of PPD/MPD) were prepared according to the method described in U.S. Pat. No. 5,886,129 (specifically Example 1). Bars made were measured to have a flex modulus of 5,800 MPa.

### Molding Methods

The resulting filled polyimide resin powder from either dry blending or Reactor blending process was converted into test specimens by direct forming (DF) at a pressure of 100,000 psi (689 MPa) at room temperature. The resulting parts were sintered for 8 hours to 150 hours at a temperature up to 420° C. under nitrogen at atmospheric pressure. After cooling to room temperature, the parts were machined to final dimensions for test specimens. Alternatively, the filled polyimide resin powder was converted into test specimens by hot molding process at a pressure of from 1,000 psi to 100.00 psi, and at a temperature from 250° C. to 420° C.

Flex modulus and dielectric constant for the test samples formed from the compositions disclosed in Tables 1 and 2 were measured, and the results are shown in Table 3.

TABLE 1

| | Examples | | | | |
|---|---|---|---|---|---|
| | 1 | 2 | 3 | 4 | 5 |
| Blending methods | A | A | A | B | B |
| Components | 46 | 45 | 44 | 45 | 50 |
| (wt %) | | | | | |
| PI | 54 | 55 | 56 | 55 | 50 |
| Mica | 46 | — | — | — | — |
| Talc | — | 45 | — | 45 | 50 |
| Kaolinite | — | — | 44 | — | — |

TABLE 2

| | Examples | | | |
|---|---|---|---|---|
| | 6 | 7 | 8 | 9 |
| Blending methods | B | B | B | N/A |
| Components | 35 | 45 | 46 | |
| (wt %) | | | | |
| PI | 65 | 55 | 54 | 100 |
| Mica | — | — | 46 | — |
| Talc | — | 45 | — | — |
| Milled kaolinite | 35 | — | — | — |

TABLE 3

| | | Flexural | Dielectric |
|---|---|---|---|
| | | modulus | Constant, 1 |
| Ex.s | Molding method | (GPa) | MHx |
| Ex. 1 | Direct forming | 9.7 | 2.9 |
| Ex. 2 | Direct forming | 7.8 | 2.6 |
| Ex. 3 | Direct forming | 10.4 | 3.9 |
| Ex. 4 | Hot molding | 11.1 | 3.4 |
| Ex. 5 | Hot molding | 10.4 | 3.4 |
| Ex. 6 | Direct forming | 11.2 | 2.9 |
| Ex. 7 | Direct forming | 10.1 | 3.6 |
| Ex. 8 | Direct forming | 10.8 | 3.0 |
| Ex. 9 | Hot molding | 5.8 | 3.3 |
| (Comp.) | | | |

What is claimed is:

1. A molded insulating polyimide article formed from a composition comprising
(A) at least one polyimide, and
(B) 30 to 70 weight % of at least one sheet silicate, based on the weight of the polyimide composition,
wherein the dielectric constant of the molded insulating polyimide article is lower than 5 and the flexural modulus of the molded insulating polyimide article is at least 7.5 GPa.

2. The molded insulating polyimide article of claim 1, wherein the sheet silicate has strong two-dimensional bonding within the silicate layers and weak inter-layer bonding, and has a Mohs hardness between 1 and 5.

3. The molded insulating polyimide article of claim 1, wherein the sheet silicate has a median particle size in a range from 0.15 microns to 100 microns.

4. The molded insulating polyimide article of claim 1, wherein the sheet silicate is selected from the group consisting of muscovite, mica, talc, sepiolite, and kaolinite.

5. The molded insulating polyimide article of claim 1, wherein the polyimide polymer is a rigid polyaromatic polyimide derived from 3,3′,4,4′-biphenyltetracarboxylic acid dianhydride (BPDA), m-phenylenediamine (MPD), and p-phenylenediamine (PPD).

6. The molded insulating polyimide article of claim 1, further comprising (C) a filler different from sheet silicate.

7. The molded insulating polyimide article of claim 1, wherein the article is selected from a test socket housing, a burn-in socket housing, a wafer level package probe head material, and a chemical mechanical polishing retainer ring.
